(19) United States
(12) Patent Application Publication
(10) Pub. No.: US 2026/0316423 A1
(43) Pub. Date: Oct. 15, 2026

(54) METHOD OF MANUFACTURING A CONSOLIDATED FIBER-REINFORCED PLASTIC COMPONENT WITH METAL SHEET REINFORCEMENT AND CONSOLIDATED FIBER-REINFORCED PLASTIC COMPONENT WITH METAL SHEET REINFORCEMENT

(71) Applicant: POLYTEC Composites NL B.V., Roosendaal (NL)

(72) Inventors: Julius RAUSCH, Heilbronn (DE); Walter VAN GILST, Lohne (DE); Martijn DE KONING, Lohne (DE)

(21) Appl. No.: 19/634,267

(22) Filed: Mar. 31, 2026

(30) Foreign Application Priority Data
Apr. 14, 2025 (DE) 10 2025 114 593.8

(51) Int. Cl. B32B 15/08; B32B 3/04; B32B 3/26; B32B 3/30; B32B 7/14; B32B 37/04; B32B 37/06; B32B 37/10; B32B 38/00

(52) U.S. Cl. CPC B32B 15/08; B32B 3/04; B32B 3/266; B32B 3/30; B32B 7/14; B32B 37/04; B32B 37/06; B32B 37/10; B32B 38/0004; B32B 2250/05; B32B 2250/42; B32B 2262/101; B32B 2398/20; B32B 2605/00

(57) ABSTRACT

Method of manufacturing a consolidated fiber-reinforced plastic component with metal sheet reinforcement for use in the underbody area of a vehicle.

### CROSS REFERENCE TO RELATED APPLICATIONS

The present application claims priority to German Patent Application 102025 114 593.8 filed Apr. 14, 2025, incorporated herein by reference.

### BACKGROUND OF INVENTION

The present invention relates to a method for manufacturing a consolidated fiber-reinforced plastic component with metal sheet reinforcement and a consolidated fiber-reinforced plastic component with metal sheet reinforcement, in particular for use in the underbody area of a vehicle.

Manufacturing methods and devices made of consolidated fiber-reinforced plastic components, in particular for sandwich components made of plastics and metal sheets, are already known from the prior art. A disadvantage of the method and devices from the prior art is that high closing forces are required for the tool presses during manufacture, particularly in the compression molding step for long-fiber-reinforced thermoplastics. This in turn means that correspondingly strong and large molding presses with high molding pressures are required for manufacture. Another disadvantage is the relatively high price of continuous fiber-reinforced fibers and thus also of the corresponding semi-finished products.

A further disadvantage of the prior art is that when using metallic sheets, these must be protected against external influences, in particular against the occurrence of corrosion, by means of suitable treatment processes. Complex manufacturing methods are therefore required to improve the mechanical component properties, in particular to increase stiffness and/or strength.

Based on the aforementioned disadvantages of the prior art, the object of the present invention is to provide an improved method of manufacturing a consolidated fiber-reinforced plastic component with metal sheet reinforcement and a consolidated fiber-reinforced plastic component with metal sheet reinforcement, in particular for use in the underbody area of a vehicle, wherein the plastic component with metal sheet reinforcement has robust mechanical properties and the manufacturing method is simplified and the economic efficiency is increased. The aforementioned object is achieved according to the invention according to a first aspect by a method of manufacturing a consolidated fiber-reinforced plastic component with metal sheet reinforcement and according to a second aspect by means of a consolidated fiber-reinforced plastic component with metal sheet reinforcement.

According to the first aspect of the invention, a method of manufacturing a consolidated fiber-reinforced plastic component with metal sheet reinforcement is provided, in particular for use in the underbody area of a vehicle, comprising the steps of:
A) assembling a layered structure comprising the sub-steps of:
   a1) providing a first layer of a fiber-reinforced thermoplastic plastic material having an upper side and a lower side, wherein the first layer comprises at least one fiber-reinforced thermoplastic plastic surface layer, wherein the at least one fiber-reinforced thermoplastic plastic surface layer is formed such that it forms a continuous plate with a plate surface along an extension plane in the consolidated component;
   a2) arranging a second layer of at least one metal sheet board having an upper side and a lower side on the upper side of the first layer, wherein the second layer covers the upper side of the first layer in at least one partial region, wherein at least one circumferential edge region of the upper side of the first layer remains uncovered by the second layer;
   a3) arranging a third layer of a fiber-reinforced thermoplastic material having an upper side and a lower side, wherein the lower side of the third layer is arranged on the upper side of the second layer and, at least in the peripheral edge region, on the upper side of the first layer and completely covers the latter, wherein the third layer comprises at least one fiber-reinforced thermoplastic surface layer, wherein the at least one fiber-reinforced thermoplastic surface layer is formed such that it forms a continuous plate with a plate surface along an extension plane in the consolidated fiber-reinforced plastic component;
B) heating the layered structure from method step A) to temperatures above the melting temperature of the thermoplastic material of the fiber-reinforced thermoplastic materials;
C) pressing the heated layered structure obtained by means of method step B) in a tool mold to obtain a consolidated fiber-reinforced plastic component, and
D) cooling the consolidated fiber-reinforced plastic component.

Preferably, the layered structure is assembled in method step A) outside the press.

According to the invention, it may be provided that the first and third layers are formed from the same thermoplastic material, wherein in method step B) the layered structure is heated to a temperature above the melting temperature of the uniform thermoplastic material of the two layers.

Alternatively, according to the invention, however, it may also be provided that the first and third layers are formed from different thermoplastics or plastic materials, each having a different melting temperature, the layered structure being heated in method step B) to a temperature above the highest melting temperature of the different thermoplastic materials.

According to the invention, the layers of the fiber-reinforced thermoplastic plastic material are formed from at least one fiber-reinforced thermoplastic surface layer, wherein the at least one surface layer in turn has reinforcing fibers arranged in a fabric-like or roving-like manner, which optionally have continuous fibers or long fibers, which are manufactured in a separate method and are impregnated with the thermoplastic materials in a second method step prior to the method according to the invention. According to the invention, the layer of the fiber-reinforced thermoplastic material can be formed from at least one continuous layer of a fiber-reinforced thermoplastic surface layer.

The plate surfaces of the first and third layer preferably have the same shape and the same dimensions along the extension plane. This means that they can preferably be aligned congruently with each other or aligned on top of each other.

According to the invention, the extension planes of the respective layers can be formed flat or planar, but according to the invention, it may also be provided that the plane also extends concavely and/or convexly curved at least in partial areas, for example to form protrusions or depressions within the consolidated fiber-reinforced plastic component. In particular, it may be provided that the layers of the fiber-reinforced thermoplastic material are formed from at least one fiber-reinforced thermoplastic plastic surface layer and in method step A) each extend along a flat plane and in method step C) curvatures are introduced into the layers at least locally along the extension plane during pressing in the tool mold in order to obtain a three-dimensional course along the extension planes of the layers.

The at least one metal sheet board of the second layer can preferably be designed as a continuous metal sheet board, wherein metal sheet board is smaller in the extension plane of the first layer than the plate surface of the first layer, so that at least one circumferential edge region of the upper side of the first layer remains uncovered by the at least one metal sheet board of the second layer. According to the invention, however, the second layer can also be formed from a plurality of metal sheet board which can be arranged either spaced apart from one another or at least locally adjacent to one another or overlapping one another on the upper side of the first layer.

Preferably, the plurality of metal sheet boards are each formed as rectangular strips and can be arranged parallel to one another on the upper side of the first layer. Here, a circumferential edge area of the upper side of the first layer remains uncovered by the metal sheet boards when the plurality of metal sheet boards are arranged on the upper side of the first layer.

According to the invention, it may be provided that the at least one metal sheet board comprises local clearances along its respective board surface, such as holes or recesses in the metal sheet board.

Preferably, method step A) additionally comprises the following sub-steps after sub-step a3):
a2) arranging a fourth layer of at least one metal sheet board having an upper side and a lower side on the upper side of the third layer, wherein the fourth layer covers the upper side of the third layer in at least one partial region, wherein at least one circumferential edge region of the upper side of the third layer remains uncovered by the fourth layer; and
a5) arranging a fifth layer of a fiber-reinforced thermoplastic material having an upper side and a lower side, wherein the fifth layer comprises at least one fiber-reinforced thermoplastic surface layer, wherein the lower side of the fifth layer is arranged on the upper side of the fourth layer and, at least in the peripheral edge region, on the upper side of the third layer and completely covers the latter, wherein the at least one fiber-reinforced thermoplastic surface layer is formed such that it forms a continuous plate with a plate surface along an extension plane in the consolidated fiber-reinforced plastic component.

The plate surfaces of the third and fifth layer preferably have the same shape and the same dimensions along the extension plane as the first and/or third layer. This means that they can be aligned congruently with each other or aligned on top of each other.

The at least one metal sheet board of the fourth layer can preferably be designed analogous to the at least one metal sheet board of the second layer, although a peripheral edge region of the upper side of the third layer remains uncovered by the at least one metal sheet board of the fourth layer.

The uncovered and circumferential edge areas between the first and third layers and/or between the third and fifth layers result in the first and third layers and/or the third and fifth layers coming to rest on each other with their respective upper and lower sides and, during the pressing of the heated layered structure, the second or fourth layers are completely enclosed by the fiber-reinforced thermoplastic fiber composite layers or embedded therein.

Preferably, the metal sheet boards are made of metal or metal alloys, in particular aluminum, steel or titanium.

Preferably, the first layer and/or the third layer and/or, if present, the fifth layer comprises a plurality of fiber-reinforced thermoplastic plastic surface layers, wherein the plurality of surface layers are arranged overlapping and/or at least adjacent to each other along the extension plane to form the respective layer and are preferably locally bonded or adhered to each other.

The terms used here for bonding or adhesion include methods such as gluing, in particular structural bonding or film bonding, welding, in particular ultrasonic welding or laser welding or hot plate welding or resistance welding, or thermal joining.

Preferably, the method comprises the following additional sub-step after method step A) and before method step B):
a6-1) arranging at least one piece of a fiber-reinforced thermoplastic material having an upper side and a lower side, as a reinforcing layer locally on the upper side of the third layer, wherein the reinforcing layer is preferably formed from at least one fiber-reinforced thermoplastic surface layer for locally increasing the wall thickness and/or for forming rib structures in the consolidated fiber-reinforced plastic component.

The wall thickness of the consolidated fiber-reinforced plastic component is measured orthogonally to the extension planes of the layers. The lower side of the first layer forms the lower side of the consolidated fiber-reinforced plastic component, the upper side of the third layer or, if present, the upper side of the fifth layer forms the upper side of the consolidated fiber-reinforced plastic component.

Preferably, the at least one piece of fiber-reinforced thermoplastic material is arranged as a reinforcing layer along the extension plane in the areas between two adjacent metal sheet boards.

Preferably, the method comprises the following additional sub-step after method step A) and before method step B):
a6-1) arranging at least one piece of a fiber-reinforced thermoplastic material having an upper side and a lower side, as a reinforcing layer locally on the upper side of the fifth layer, wherein the reinforcing layer is preferably formed from at least one fiber-reinforced thermoplastic surface layer for locally increasing the wall thickness and/or for forming ribs in the consolidated fiber-reinforced plastic component.

The at least one piece of the fiber-reinforced thermoplastic material can, for example, be formed in strips to form ribs extending in strips on the upper side of the fifth layer.

Preferably, the first and third layers are aligned one above the other along the respective extension plane so that the plate surfaces of the layers coincide in the extension plane and/or, if a fifth layer is present, the third and fifth layers are aligned one above the other along the respective extension plane so that the plate surfaces coincide in the extension plane.

Here, the layers form common flanks or side surfaces in the consolidated fiber-reinforced plastic component.

Preferably, the method additionally comprises the following method step before method step A):
a0-1) cutting the at least one fiber-reinforced thermoplastic surface layer to form the respective layer of the fiber-reinforced thermoplastic material.

Preferably, the method additionally comprises the following method step before method step A):
a0-2) cutting the at least one metal sheet board to form the second and/or, if present, the fourth layer, in particular to a smaller dimension than the plate surface of the fiber-reinforced thermoplastic layers, so that the second and/or fourth layer in the consolidated fiber-reinforced plastic component is enclosed by the respective layers of the fiber-reinforced thermoplastic material.

Here, the smaller size of the metal sheet boards than the plate surface of the fiber-reinforced thermoplastic layers particularly allows the metal sheet boards to be arranged such that the edge areas of the first, third and possibly fifth layer remain uncovered by the metal sheets. Preferably, the first, third and possibly fifth layer can thus be bonded or adhered and/or thermally joined together, in particular in the edge regions, so that the at least one metal sheet board of the second and/or fourth layer is enclosed by the respective layers of the fiber-reinforced thermoplastic material. In particular, this allows the edge areas of the first, third and possibly fifth layer to be formed in the press, for example, to form a convex wall shape without the need for a forming step for the metal sheet boards.

Preferably, the method additionally comprises the following method step before method step A):
a0-3) treating the upper side and/or lower side of the at least one metal sheet board of the second and/or fourth layer to improve the adhesion properties with respect to the fiber-reinforced thermoplastic material.

In this case, the step of treating the upper side and/or lower side of the at least one metal sheet board of the second and/or fourth layer to improve the adhesion properties with respect to the fiber-reinforced thermoplastic material comprises coating the upper side and/or lower side with an adhesion promoter, in particular with a polymeric adhesion promoter. The adhesion promoter can be applied to the respective surface or applied in a film-shape, for example.

Preferably, the method comprises the following additional sub-step after method step a6-1) and before method step B):
a7-1) punctually bonding or adhering the lower side of the at least one piece of the reinforcing layer to the upper side of the third layer;
or additionally comprising the following sub-step after method step a6-2) and before method step b):
a7-1) punctually bonding or adhering the lower side of the at least one piece of the reinforcing layer to the upper side of the fifth layer;

The reinforcing layer is fixed locally to the top side of the fiber-reinforced thermoplastic material of the third or fifth layer by the punctual bonding or by punctual adhering and is thus secured against slipping. This facilitates safe handling of the layered structure before it is consolidated, without the risk of the individual layers slipping against each other.

Preferably, method step A) additionally comprises the sub-step of:
a8) punctually bonding or adhering the respective layer of the at least one metal sheet board to the upper side of the layer arranged directly below the layer of the at least one metal sheet board and/or the lower side of the layer located directly above it.

The at least one metal sheet board is fixed locally on the upper side of the layer located directly below and/or the lower side of the layer of fiber-reinforced thermoplastic material located directly above by the punctual bonding or adhering and is thus secured against slipping. This in turn facilitates the handling of the layered structure.

Preferably, method step A) additionally comprises the sub-step of:
a9) punctually bonding or adhering the upper side and the opposite lower side of two superimposed surface areas of the layers of a fiber-reinforced thermoplastic material.

Here, the adjacent layers are at least partially thermally bonded to each other, in particular at edge points of the respective layers to form a layered structure that is handling-stable.

Preferably, in method step C), the layered structure is sequentially pressed in the tool mold with leading and trailing tool areas, in particular using a shear edge tool, to form different wall thicknesses and/or profiled upper sides and/or lower sides in the consolidated fiber-reinforced plastic component, in particular ribs on the upper side and/or lower side of the consolidated fiber-reinforced plastic component, wherein the areas with an increased wall thickness are pressed by trailing tool areas.

Preferably, the molding pressure of the leading and trailing tool areas is the same. Alternatively, the molding pressure of the leading tool areas can be greater or smaller than the molding pressure of the trailing tool areas. Preferably, the trailing tool areas are configured for locally limited compression molding, for example in the area of the reinforcing layer. Preferably, the leading tool areas are arranged for pressing the basic structure comprising the first, second, third and, if applicable, fourth and fifth layers.

Preferably, the method further comprises the method step according to method step D):
E) making recesses in the consolidated fiber-reinforced plastic component in one and/or trimming the plate surface of the layers.

Here, the consolidated fiber-reinforced plastic component can be reworked, preferably by machining, for example to form connection points or specific geometric shapes.

Preferably, the consolidated fiber-reinforced plastic component is post-processed using a punch press and/or the post-processing comprises at least one of the steps of drilling, milling, water jet cutting or laser cutting.

The punching press enables precise and fast processing, especially of hard materials. Post-processing by means of drilling, milling, water jet cutting and/or laser cutting enables, for example, the creation of individual recesses and/or geometrically sophisticated recesses and/or undercuts.

Preferably, after method step E), screwing points are formed on the consolidated fiber-reinforced plastic component, in particular by placing inserts and/or bushes, in particular for fastening to a vehicle underbody.

Preferably, the screwing points are formed in the previously reworked recesses. Alternatively or additionally, the screwing points are formed independently of the recesses.

Preferably, the structure and/or the consolidated fiber-reinforced plastic component is picked up and transferred between the method steps using a handling gripper, in particular a vacuum gripper and/or a needle gripper.

In particular, the consolidated fiber-reinforced plastic component is transferred between the individual method steps and/or sub-steps. According to the invention, the consolidated fiber-reinforced plastic component can also be moved, in particular displaced, during a method step or sub-step using a handling gripper.

Preferably, the layers of the fiber-reinforced thermoplastic material have the same material properties or have different material properties, in particular different fiber densities and/or different porosity and/or different fiber types and/or different flame retardant additives.

Preferably, the first layer, in particular the lower side of the first layer, has flame retardant additives in order to protect the consolidated fiber-reinforced plastic component on the road side when used in the area of the underbody of a vehicle.

In particular, the third and/or fifth layer can have a higher pore volume content than the underlying layers of fiber-reinforced thermoplastic material.

Preferably, the respective metal sheet layer is pre-stamped into a three-dimensional shape before method step A), in particular to form beads.

This can improve the mechanical consolidated fiber-reinforced plastic component properties, in particular the stiffness and/or strength of the consolidated fiber-reinforced plastic component.

According to the invention, in a preferred embodiment, the layers of the fiber-reinforced thermoplastic material can each be formed as glass fiber mat-reinforced thermoplastic materials (GMT). In this case, the GMT are formed from at least one glass fiber mat-reinforced thermoplastic surface layer, wherein the at least one surface layer comprises glass fiber mats which comprise continuous glass fibers or long-fiber glass fibers which are produced in a separate method and are impregnated with the thermoplastic materials in a further method step, wherein the aforementioned method steps take place before the method steps according to the invention.

According to a second aspect of the invention, a consolidated fiber-reinforced plastic component with metal sheet reinforcement is provided according to the invention, preferably for use in the underbody area of a vehicle, in particular produced according to a method according to a first aspect of the present invention, comprising:
a first layer of a fiber-reinforced thermoplastic plastic material having an upper side and a lower side, wherein the first layer comprises at least one fiber-reinforced thermoplastic plastic surface layer, wherein the at least one fiber-reinforced thermoplastic plastic surface layer is formed such that it forms a continuous plate with a plate surface along an extension plane in the consolidated fiber-reinforced plastic component;
a second layer of at least one metal sheet board having an upper side and a lower side, wherein the second layer covers the upper side of the first layer in at least one partial region, wherein at least one circumferential edge region of the upper side of the first layer remains uncovered by the second layer;
a third layer of a fiber-reinforced thermoplastic material having an upper side and a lower side, wherein the lower side of the third layer is arranged on the upper side of the second layer and, at least in the peripheral edge region, on the upper side of the first layer and completely covers the latter, wherein the third layer comprises at least one fiber-reinforced thermoplastic surface layer, wherein the at least one fiber-reinforced thermoplastic surface layer is formed such that it forms a continuous plate with a plate surface along an extension plane in the consolidated fiber-reinforced plastic component.

Preferably, the consolidated fiber-reinforced plastic component additionally comprises:
a fourth layer of at least one metal sheet board having an upper side and a lower side on the upper side of the third layer, wherein the fourth layer covers the upper side of the third layer in at least one partial region, wherein at least one circumferential edge region of the upper side of the third layer is uncovered by the fourth layer; and
a fifth layer of a fiber-reinforced thermoplastic material having an upper side and a lower side, wherein the fifth layer comprises at least one fiber-reinforced thermoplastic surface layer, wherein the lower side of the fifth layer is arranged on the upper side of the fourth layer and, at least in the peripheral edge region, on the upper side of the third layer and completely covers the latter, wherein the at least one fiber-reinforced thermoplastic surface layer is formed such that it forms a continuous plate with a plate surface along an extension plane in the consolidated fiber-reinforced plastic component.

Preferably, the consolidated fiber-reinforced plastic component additionally comprises:
at least one piece of a fiber-reinforced thermoplastic material having an upper side and a lower side, as a reinforcing layer locally on the upper side of the third layer, wherein the reinforcing layer is preferably formed from at least one fiber-reinforced thermoplastic surface layer for locally increasing the wall thickness in the consolidated fiber-reinforced plastic component and/or for forming surface profiles.

Preferably, the layers of the fiber-reinforced thermoplastic material are formed at least proportionally from glass fiber mat-reinforced thermoplastic materials (GMT), wherein the layer of the at least one fiber-reinforced thermoplastic surface layer is formed as at least one glass fiber mat-reinforced thermoplastic surface layer.

According to the invention, in a preferred embodiment, the layers of the fiber-reinforced thermoplastic material can each be formed as glass fiber mat-reinforced thermoplastic materials (GMT), which in turn are formed from at least one glass fiber mat-reinforced thermoplastic surface layer, wherein the at least one surface layer comprises glass fiber mats which comprise continuous glass fibers or long-fiber glass fibers which are produced in a separate method and are impregnated with the thermoplastic materials in a further method step, wherein the aforementioned method steps take place before the method steps according to the invention.

Preferably, the lower side of the first layer forms the lower side of the consolidated fiber-reinforced plastic component, the upper side of the third layer or, if present, the upper side of the fifth layer forms the upper side of the consolidated fiber-reinforced plastic component. Preferably, the lower side of the consolidated component is aligned with the side of the road and the upper side of the consolidated component is aligned with the vehicle.

Preferably, the method is further developed using the features of the consolidated fiber-reinforced plastic component described above and inverted.

In the following, exemplary embodiments according to the invention of the method and consolidated fiber-reinforced plastic component according to the invention are explained below with reference to the accompanying figures.

### IN THE FIGURES

FIG. 1A is schematic illustration in side view of a first layer of a fiber-reinforced thermoplastic material according to an exemplary embodiment of the present invention;

FIG. 1B is schematic illustration in top view of a first layer of a fiber-reinforced thermoplastic material according to an exemplary embodiment of the present invention;

FIG. 2A is schematic illustration in top view of a second layer of a continuous metal sheet board according to an exemplary embodiment of the present invention;

FIG. 2B is schematic illustration in top view of a second layer of a plurality of spaced metal sheet boards according to an exemplary embodiment of the present invention;

FIG. 2C is schematic illustration in top view of a second layer of a metal sheet board with local clearances according to an exemplary embodiment of the present invention;

FIG. 3A is schematic illustration in side view of a first layer of a fiber-reinforced thermoplastic material with a second layer of a plurality of spaced metal sheet boards according to an exemplary embodiment of the present invention;

FIG. 3B is schematic illustration in top view of a first layer of a fiber-reinforced thermoplastic material with a second layer of a plurality of spaced metal sheet boards according to an exemplary embodiment of the present invention;

FIG. 4A is schematic illustration in side view of a first layer of a fiber-reinforced thermoplastic material with an adhered second layer of a plurality of spaced metal sheet boards according to an exemplary embodiment of the present invention;

FIG. 4B is schematic illustration in top view of a first layer of a fiber-reinforced thermoplastic material with a second layer of a plurality of spaced metal sheet boards with adhesion points according to an exemplary embodiment of the present invention;

FIG. 5A is schematic illustration in side view of a first layer and a third layer of a fiber-reinforced thermoplastic material with a adhered second layer of a plurality of spaced metal sheet boards according to an exemplary embodiment of the present invention;

FIG. 5B is schematic illustration in top view of a third layer of a fiber-reinforced thermoplastic material with a second layer of a plurality of spaced metal sheet boards according to an exemplary embodiment of the present invention;

FIG. 6A is schematic illustration in side view of a first layer and a third layer of a fiber-reinforced thermoplastic material with a adhered second layer of a plurality of spaced metal sheet boards and with a adhered reinforcing layer according to an exemplary embodiment of the present invention;

FIG. 6B is schematic illustration in top view of a third layer of a fiber-reinforced thermoplastic material with a reinforcing layer s according to an exemplary embodiment of the present invention;

FIG. 7 is schematic illustration in side view of a first layer, a third layer and a fifth layer of a fiber-reinforced thermoplastic material with an adhered second layer and fourth layer of a plurality of spaced metal sheet boards and with an adhered reinforcing layer according to an exemplary embodiment of the present invention;

FIG. 8 is schematic illustration of a layered structure in the tool mold in side view with leading and trailing leading and trailing tool area according to an exemplary embodiment of the present invention;

FIG. 9 is schematic illustration of a consolidated fiber-reinforced plastic component with sheet metal reinforcement according to an exemplary embodiment of the present invention.

### DETAILED DESCRIPTION OF DISCLOSURE

The exemplary embodiments shown are schematic illustration, so that the present invention is not limited to the dimensions and/or length ratios shown. Furthermore, the number of features shown is exemplary and may therefore differ from the number shown.

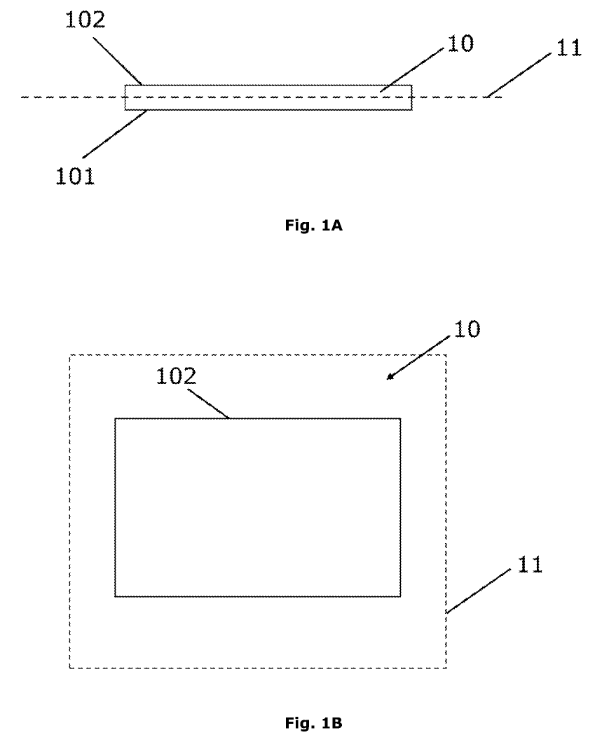

In an exemplary embodiment of the present invention, FIG. 1A shows a schematic side view of a first layer 10 of a fiber-reinforced thermoplastic material having an upper side 102 and an opposite lower side 101. Preferably, a third 20 and/or fifth layer 30 of a fiber-reinforced thermoplastic material is formed analogously to the first layer 10. As an example, the extension plane 11 of the first layer 10 is shown for illustration purposes, wherein this is merely a virtual reference plane.

In an exemplary embodiment of the present invention, FIG. 1B shows a schematic top view of a first layer 10 of a fiber-reinforced thermoplastic material having an upper side 102 and the virtual extension plane 11, wherein the extension plane 11 as a reference plane is not limited in dimensions to a surface. Here, the first layer 10 of the fiber-reinforced thermoplastic material is exemplarily formed as a continuous layer of a fiber-reinforced thermoplastic surface layer. Preferably, the first layer 10 comprises at least one fiber-reinforced thermoplastic surface layer, wherein the at least one surface layer can have reinforcing fibers arranged in a fabric-like or roving-like manner, which preferably has continuous fibers or long fibers. As shown in the exemplary embodiments of FIGS. 1A and 1B, the extension plane 11 of the first layer 10 is flat or planar. However, the extension plane can also be concavely and/or convexly curved, at least in partial areas, for example to form protrusions or depressions within the consolidated component.

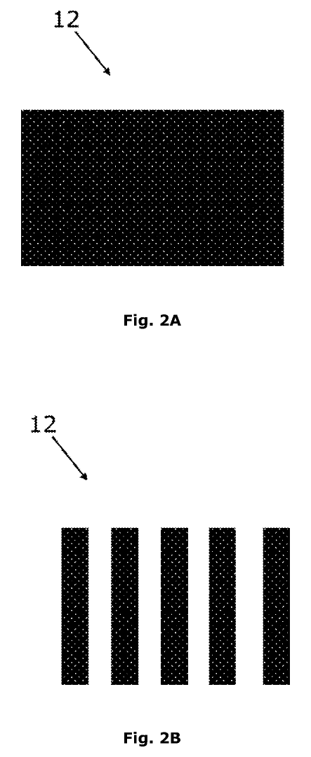

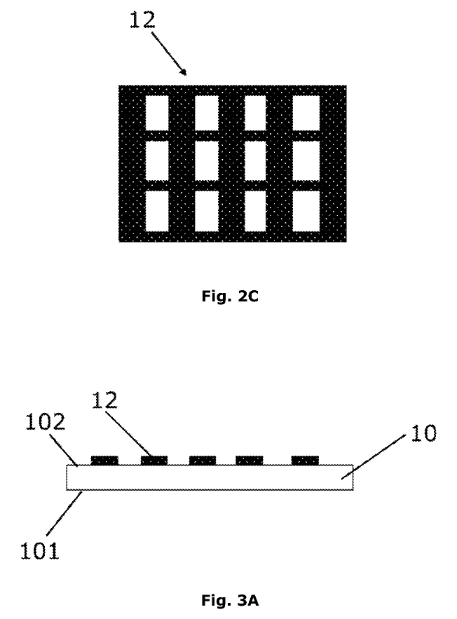

FIGS. 2A to 2C show a schematic illustration in top view of a second layer 12 of at least one metal sheet board in exemplary embodiments of the present invention. Preferably, a fourth layer 14 of at least one metal sheet board is formed analogously to the second layer 12. In particular, the at least one metal sheet board of the second layer 12 in the extension plane 11 of the first layer 10 is designed to be smaller than the plate surface of the first layer 10, so that at least one circumferential edge region of the upper side 102 of the first layer 10 remains uncovered by the at least one metal sheet board of the second layer 12.

As shown in FIG. 2A, the at least one metal sheet board of the second layer 12 can preferably be formed as a continuous metal sheet board. Alternatively, the second layer 12 can also be formed from several metal sheet boards. The metal sheets boards can be arranged at a distance from each other, as shown schematically in FIG. 2B. Alternatively or additionally, a plurality of metal sheet boards can also be arranged at least locally adjacent to each other or overlapping each other. Preferably, a plurality of metal sheet boards are designed as rectangular strips and arranged parallel to each other, in particular. FIG. 2C shows a further embodiment of the second layer 12, wherein the at least one metal sheet board comprises local clearances in the form of recesses. Alternatively or additionally, the local clearances can also be designed as holes or slots, for example.

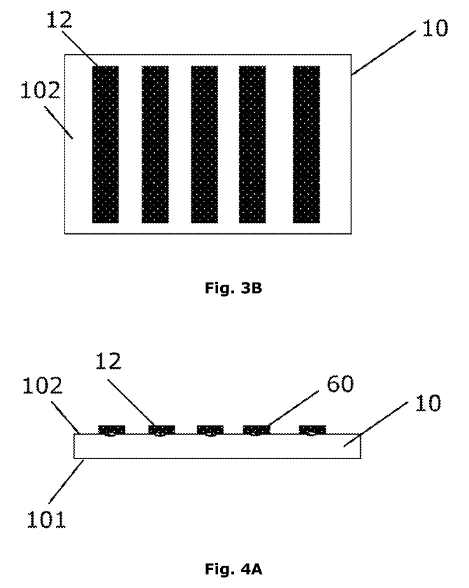

In an exemplary embodiment of the present invention, FIG. 3A shows a layered structure with a first layer 10 and a second layer 12 in a side view. Here, the second layer 12 consists of a plurality of spaced metal sheet boards arranged on the upper side 102 of the first layer. As shown in FIG. 3B, a plurality of metal sheet boards of the second layer 12 may be formed as rectangular strips and arranged parallel to each other on the upper side 102 of the first layer 10. Here, the second layer 12 is arranged such that at least one circumferential edge area of the first layer 10 is not covered by the metal sheet boards of the second layer.

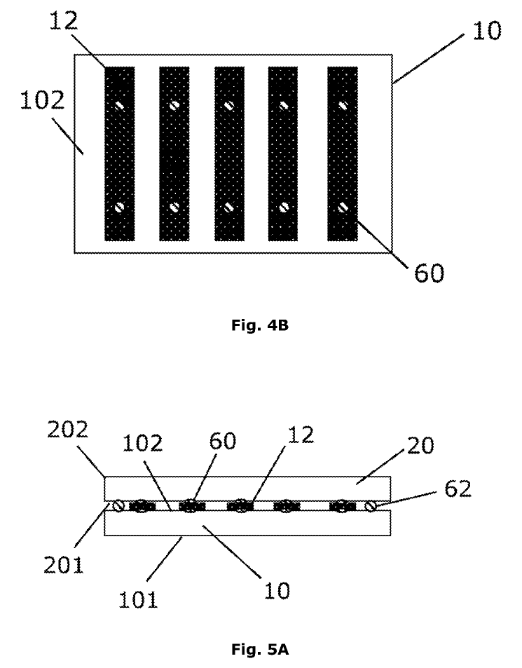

In FIG. 4A, an exemplary embodiment is shown, wherein the lower side of the second layer 12 is punctually 60 bonded or adhered to the upper side 102 of the first layer 10. Thus, the metal sheet boards of the second layer 12 are secured against slipping on the surface 102 of the first layer 10 in the layered structure. Alternatively or additionally, punctual 60 bonding or adhesion can also be formed on the upper side of the second layer 12 to secure the second layer against slipping with the lower side 201 of the third layer 20.

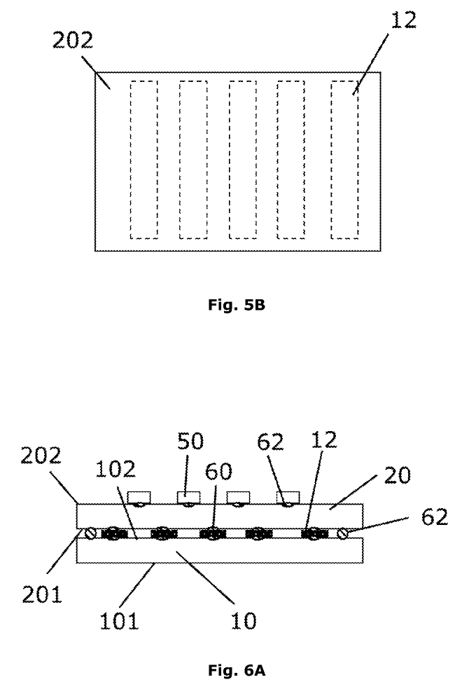

FIG. 5A shows a layered structure in an exemplary embodiment comprising a first layer 10 having a lower side 101 and an upper side 102, a second layer 12 punctually bonded or adhered 60 to the upper side 102, wherein the second layer 12 comprises a plurality of spaced metal sheet boards, and a third layer 20 having a lower side 201 and an upper side 202, wherein the third layer comprises at least one fiber-reinforced thermoplastic surface layer and is punctually bonded or adhered 60 on the lower side 201 to the upper side of the second layer 12. The lower side 201 of the third layer 20 is preferably punctually 62 bonded to the upper side 102 of the first layer 10. In particular, the first layer 10 and the third layer 20 are bonded to each other in the edge areas. Alternatively or additionally, however, the first layer 10 and the third layer 20 can preferably also be punctually bonded to one another in areas uncovered by the second layer 12. The punctual bondings 62 of the first and third layers may be the same punctual bondings or adhesions 60 as between the first 10 or third layer 20 and the second layer 12. Alternatively, the bondings 62 between the first 10 and third layers 20 are different from the bondings or adhesions 60 of the first 10 or third layer 20 to the second layer 12.

FIG. 5B shows a top view of the layered structure in an exemplary embodiment with the upper side 202 of the third layer 20, wherein the second layer 12 located between the first 10 and third layer 20 is merely indicated for illustration purposes.

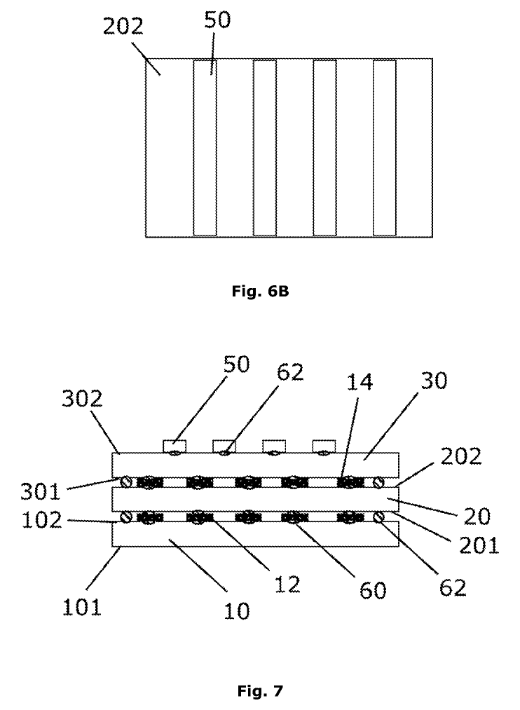

FIG. 6A shows an exemplary embodiment, wherein the layered structure comprises, in addition to the first layer 10, the second layer 12 and the third layer 20, a reinforcing layer 50 on the upper side 202 of the third layer 20. The reinforcing layer 50 is preferably made of at least one fiber-reinforced thermoplastic surface layer, so that the wall thickness can be increased locally and/or rib structures can be formed in the consolidated component. Preferably, the at least one piece of fiber-reinforced thermoplastic material is arranged as a reinforcing layer in the areas between two adjacent metal sheet boards, as shown in FIG. 6A. Preferably, the reinforcing layer 50 is punctually 62 bonded on the lower side to the upper side 202 of the third layer 20, so that the reinforcing layer is secured against slipping in the layered structure. The punctual bonding or adhesion between the layers creates a handling-stable layered structure that can be transferred between the individual method steps or relocated during a method step or sub-step, particularly by handling grippers.

FIG. 6B shows the layered structure in an exemplary embodiment in a top view, wherein the reinforcing layer 50 is arranged in the form of a plurality of spaced strips of fiber-reinforced thermoplastic material on the upper side 202 of the third layer 20.

FIG. 7 shows a further embodiment of the present invention, wherein the layered structure comprises a first layer 10, a second layer 12, a third layer 20, a fourth layer 14, a fifth layer 30 and a reinforcing layer 50. The second and fourth layers are each punctually 60 bonded or adhered to the corresponding upper side 102, 201 or lower side 201, 301 of the immediately adjacent layers 10, 20, 30. The upper side 102 of the first layer 10 is punctually bonded 62 to the lower side 201 of the second layer 20, and the upper side 202 of the second layer 20 is punctually bonded 62 to the lower side 301 of the fifth layer 30. The lower side of the reinforcing layer 50 is punctually bonded to the upper side 302 of the fifth layer 30. Here, the first layer 10, the third layer 20 and the fifth layer 30 are aligned flush with each other. Preferably, the second layer 12 and the fourth layer 14 are aligned on top of each other to form a sandwich structure. In particular, the reinforcing layer 50 is arranged in the areas between two adjacent metal sheet boards of the second 12 and fourth layer 14.

Preferably, the layers of the fiber-reinforced thermoplastic material are formed in individual or all embodiments at least proportionally from glass fiber mat-reinforced thermoplastic materials (GMT), wherein the layer of the at least one fiber-reinforced thermoplastic surface layer is formed as at least one glass fiber mat-reinforced thermoplastic surface layer.

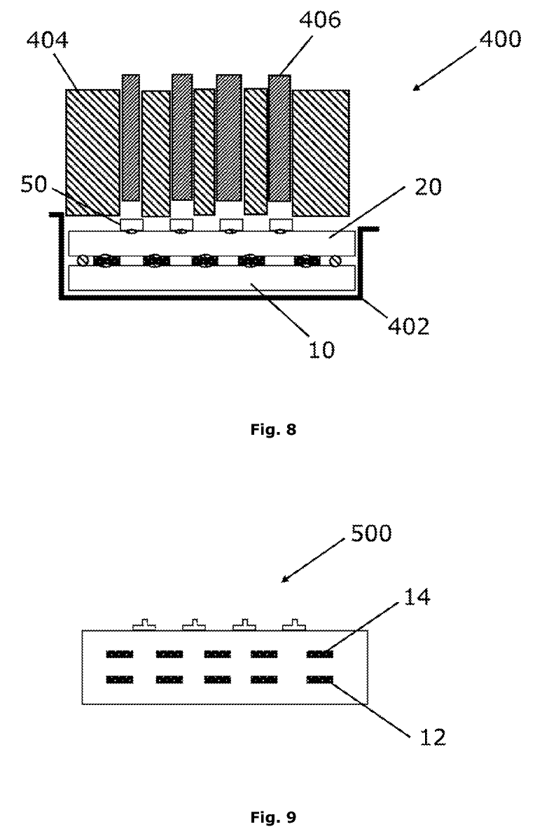

FIG. 8 shows the pressing 400 of the heated layered structure in an exemplary embodiment. The layered structure is arranged in a tool mold 402, wherein the first layer 10 is aligned with the tool mold bottom and the reinforcing layer 50 is aligned with the pressing tools. The pressing tools have leading tool areas 404 and trailing tool areas 406 so that the layered structure can be pressed sequentially.

FIG. 9 shows a consolidated fiber-reinforced plastic component 500 with metal sheet reinforcement 12, 14 in a schematic illustration according to an exemplary embodiment of the present invention. In the consolidated component, the first 10, third 20 and fifth layer 30 each form common side walls and completely enclose the metal sheet boards of the second 12 and fourth layer 14. This protects the metal sheet boards against corrosion. The reinforcing layer 50 forms a rib structure on the upper side of the consolidated component 500, wherein screwing points can preferably be formed in the rib structure, for example by placing inserts and/or bushings, in particular for fastening to a vehicle underbody.

What is claimed is:

1. A method of manufacturing a consolidated fiber-reinforced plastic component with metal sheet reinforcement for use in the underbody area of a vehicle, comprising the steps of:
a) assembling a layered structure comprising the sub-steps of:
a1) providing a first layer of a fiber-reinforced thermoplastic plastic material having an upper side and a lower side, wherein the first layer comprises at least one fiber-reinforced thermoplastic plastic surface layer, wherein the at least one fiber-reinforced thermoplastic plastic surface layer is formed such that it forms a continuous plate with a plate surface along an extension plane in the consolidated component;
a2) arranging a second layer of at least one metal sheet board having an upper side and a lower side on the upper side of the first layer, wherein the second layer covers the upper side of the first layer in at least one partial region, wherein at least one circumferential edge region of the upper side of the first layer remains uncovered by the second layer; and
a3) arranging a third layer of a fiber-reinforced thermoplastic material having an upper side and a lower side, wherein the lower side of the third layer is arranged on the upper side of the second layer and, at least in the peripheral edge region, on the upper side of the first layer and completely covers the latter, wherein the third layer comprises at least one fiber-reinforced thermoplastic surface layer, wherein the at least one fiber-reinforced thermoplastic surface layer is formed such that it forms a continuous plate with a plate surface along an extension plane in the consolidated component;
b) heating the layered structure from method step a) to temperatures above the melting temperature of the thermoplastic material of the fiber-reinforced thermoplastic materials;
c) pressing the heated layered structure obtained by means of method step b) in a tool mold to obtain a consolidated fiber-reinforced plastic component; and
d) cooling the consolidated fiber-reinforced plastic component.

2. The method according to claim 1, wherein method step a) additionally comprises the sub-steps of:
a4) arranging a fourth layer of at least one metal sheet board having an upper side and a lower side on the upper side of the third layer, wherein the fourth layer covers the upper side of the third layer in at least one partial region, wherein at least one circumferential edge region of the upper side of the third layer remains uncovered by the fourth layer; and
a5) arranging a fifth layer of a fiber-reinforced thermoplastic material having an upper side and a lower side, wherein the fifth layer comprises at least one fiber-reinforced thermoplastic surface layer, wherein the lower side of the fifth layer is arranged on the upper side of the fourth layer and, at least in the peripheral edge region, on the upper side of the third layer and completely covers the third layer, wherein the at least one fiber-reinforced thermoplastic surface layer is formed such that it forms a continuous plate with a plate surface along an extension plane in the consolidated fiber-reinforced plastic component.

3. The method according to claim 1, wherein the first layer and/or the third layer and/or, if present, the fifth layer comprises a plurality of fiber-reinforced thermoplastic plastic surface layers, wherein the plurality of surface layers are arranged overlapping and/or at least adjacent to each other along the extension plane to form the respective layer.

4. The method according to claim 1, additionally comprising the following sub-step after method step a) and before method step b):
a6-1) arranging at least one piece of a fiber-reinforced thermoplastic material having an upper side and a lower side, as a reinforcing layer locally on the upper side of the third layer.

5. The method according to claim 2, additionally comprising the following sub-step after method step a) and before method step b):
a6-1) arranging at least one piece of a fiber-reinforced thermoplastic material having an upper side and a lower side, as a reinforcing layer locally on the upper side of the fifth layer.

6. The method according to claim 1, wherein the first and third layers are aligned one above the other along the respective extension plane so that the plate surfaces of the layers coincide in the extension plane and/or, if a fifth layer is present, the third and fifth layers are aligned one above the other along the respective extension plane so that the plate surfaces coincide in the extension plane.

7. The method according to claim 1, additionally comprising the following method step before method step a):
a0-1) cutting the at least one fiber-reinforced thermoplastic surface layer to form the respective layer of the fiber-reinforced thermoplastic material.

8. The method according to claim 1, additionally comprising the following method step before method step a):
a0-2) cutting the at least one metal sheet board to form the second and/or, if present, the fourth layer, in particular to a smaller dimension than the plate surface of the fiber-reinforced thermoplastic layers, so that the second and/or fourth layer in the consolidated fiber-reinforced plastic component is enclosed by the respective layers of the fiber-reinforced thermoplastic material.

9. The method according to claim 1, additionally comprising the following method step before method step a):
a0-3) treating the upper side and/or lower side of the at least one metal sheet board of the second and/or fourth layer to improve the adhesion properties with respect to the fiber-reinforced thermoplastic material.

10. The method according to claim 4, additionally comprising the following sub-step after method step a6-1) and before method step b):
a7-1) punctually bonding or adhering the lower side of the at least one piece of the reinforcing layer to the upper side of the third layer.

11. The method according to claim 1, wherein method step a) additionally comprises the sub-step of:
a8) punctually bonding or adhering the respective layer of the at least one metal sheet board to the upper side of the layer arranged directly below the layer of the at least one metal sheet board and/or the lower side of the layer located directly above it.

12. The method according to claim 1, wherein method step a) additionally comprises the sub-step of:
a9) punctually bonding or adhering the upper side and the opposite lower side of two superimposed surface areas of the layers of a fiber-reinforced thermoplastic material.

13. The method according to claim 1, wherein in method step c) the layered structure is sequentially pressed in the tool mold with leading and trailing tool areas, to form different wall thicknesses and/or profiled upper sides and/or lower sides in the consolidated fiber-reinforced plastic component, wherein the areas with an increased wall thickness are pressed by trailing tool areas.

14. The method according to claim 1, further comprising the following method step after method step d):
e) making recesses in the consolidated fiber-reinforced plastic component and/or trimming the plate surface of the layers.

15. The method according to claim 14, wherein the consolidated fiber-reinforced plastic component is post-processed using a punch press and/or the post-processing comprises at least one of the steps of drilling, milling, water jet cutting or laser cutting.

16. The method according to claim 13, wherein after method step e) screwing points are formed on the consolidated fiber-reinforced plastic component.

17. The method according to claim 1, wherein the structure and/or the consolidated fiber-reinforced plastic component is picked up and transferred between the method steps using a handling gripper.

18. The method according to claim 1, wherein the layers of the fiber-reinforced thermoplastic material have different material properties from each other.

19. The method according to claim 1, wherein the respective metal sheet layer is pre-stamped into a 3D shape before method step a).

20. The method according to claim 1, wherein the layers of the fiber-reinforced thermoplastic material are formed at least partially from glass fiber mat-reinforced thermoplastic materials (GMT), wherein the layer of the at least one fiber-reinforced thermoplastic surface layer is formed as at least one glass fiber mat-reinforced thermoplastic surface layer.

21. A consolidated fiber-reinforced plastic component with sheet metal reinforcement for use in the underbody area of a vehicle comprising:
a first layer of a fiber-reinforced thermoplastic plastic material having an upper side and a lower side, wherein the first layer comprises at least one fiber-reinforced thermoplastic plastic surface layer, wherein the at least one fiber-reinforced thermoplastic plastic surface layer is formed such that it forms a continuous plate with a plate surface along an extension plane in the consolidated fiber-reinforced plastic component;
a second layer of at least one metal sheet board having an upper side and a lower side, wherein the second layer covers the upper side of the first layer in at least one partial region, wherein at least one circumferential edge region of the upper side of the first layer remains uncovered by the first layer;
a third layer of a fiber-reinforced thermoplastic material having an upper side and a lower side, wherein the lower side of the third layer is arranged on the upper side of the second layer and, at least in the peripheral edge region, on the upper side of the first layer and completely covers the first layer wherein the third layer comprises at least one fiber-reinforced thermoplastic surface layer, wherein the at least one fiber-reinforced thermoplastic surface layer is formed such that it forms a continuous plate with a plate surface along an extension plane in the consolidated fiber-reinforced plastic component.

22. The consolidated fiber-reinforced plastic component according to claim 21, additionally comprising:
a fourth layer of at least one metal sheet board having an upper side and a lower side on the upper side of the third layer, wherein the fourth layer covers the upper side of the third layer in at least one partial region, wherein at least one circumferential edge region of the upper side of the third layer is uncovered by the fourth layer; and
a fifth layer of a fiber-reinforced thermoplastic material having an upper side and a lower side, wherein the fifth layer comprises at least one fiber-reinforced thermoplastic surface layer, wherein the lower side of the fifth layer is arranged on the upper side of the fourth layer and, at least in the peripheral edge region, on the upper side of the third layer and completely covers the third layer, wherein the at least one fiber-reinforced thermoplastic surface layer is formed such that it forms a continuous plate with a plate surface along an extension plane in the consolidated fiber-reinforced plastic component.

23. The consolidated fiber-reinforced plastic component according to claim 20, additionally comprising:
at least one piece of a fiber-reinforced thermoplastic material having an upper side and a lower side, as a reinforcing layer locally on the upper side of the third layer.

24. The consolidated fiber-reinforced plastic component according to claim 21, wherein the layers of the fiber-reinforced thermoplastic material are formed at least partially from glass fiber mat-reinforced thermoplastic materials (GMT), wherein the layer of the at least one fiber-reinforced thermoplastic surface layer is formed as at least one glass fiber mat-reinforced thermoplastic surface layer.
